(19) United States
(12) Patent Application Publication
(10) Pub. No.: US 2009/0313655 A1
(43) Pub. Date: Dec. 17, 2009

(54) Apparatus, method, computer program and user interface for enabling access to programs.

(75) Inventors: Christian Rossing Kraft, Frederiksberg C (DK); Joakim Christoffersson, Malmo (SE); Pia Breum Nielsen, Copenhagen S (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/157,629

(22) Filed: Jun. 12, 2008

(51) Int. Cl. H04N 5/445

(52) U.S. Cl. 725/44

(57) ABSTRACT

A method, and associated apparatus, computer program and user interface, the method including receiving information comprising the trigger time of programs on a plurality of media channels; assigning a priority to the programs based on the trigger time of the program relative to a given time point such that programs with a trigger time within a first predetermined time interval of the given time point are assigned a higher priority than programs with a trigger time within a second predetermined time interval of the given time point; and presenting, at the given time point, the programs in a list in order of assigned priority so that programs with a higher assigned priority are presented at a higher position in the list than programs with a lower assigned priority and user selection of a program from the list enables the media channel associated with the selected program to be accessed.

### FIELD OF THE INVENTION

Embodiments of the present invention relate to an apparatus, method, computer program and user interface for enabling access to programs. In particular, they relate to an apparatus, method, computer program and user interface for enabling access to television programs.

### BACKGROUND TO THE INVENTION

Apparatus and methods of providing electronic program guides which enable a user to view a list of scheduled television programs are well known. A user may view a television program by selecting a program from the electronic program guide.

In some situations there may be a large number of channels available to the user, in which case it may take the user a significant amount of time to navigate through the electronic program guide to find a program which they wish to view. Also the apparatus may have a limited user interface, for example in a hand held communications device the apparatus may have a small display relative to a conventional television and only a limited user input device. This may make it more inconvenient and also increase the time it takes a user to navigate through an electronic program guide.

### BRIEF DESCRIPTION OF VARIOUS EMBODIMENTS OF THE INVENTION

According to various, but not necessarily all, embodiments of the invention there is provided a method comprising; receiving information comprising the trigger time of programs on a plurality of media channels; assigning a priority to the programs based on the trigger time of the program relative to a given time point such that programs with a trigger time within a first predetermined time interval of the given time point are assigned a higher priority than programs with a trigger time within a second predetermined time interval of the given time point; and presenting, at the given time point, the programs in a list in order of assigned priority so that programs with a higher assigned priority are presented at a higher position in the list than programs with a lower assigned priority and user selection of a program from the list enables the media channel associated with the selected program to be accessed.

This provides the advantage that the list of programs available can be presented in a list, such as an electronic program guide, in an order which is dependent on the trigger times of the programs so that programs which the user is most likely to want to access are presented at the top of the list. This reduces the amount of time it would take a user to select a program because the user does not need to scroll through a large amount of information before finding a program with a suitable trigger time.

According to some embodiments of the invention the trigger time may be the start time of the program.

This provides the advantage that it enables a user to quickly and easily access programs which have just started or which are just about to start. This is particularly advantageous for users who are only planning to access the channel for a short period of time but would like to watch an entire program from the beginning in that time. For example, a user who is watching mobile television whilst traveling may only want to view a program while they are traveling but would not want to watch a program which has already started.

According to some embodiments of the invention the plurality of media channels may comprise television channels.

According to some embodiments of the invention any one of a plurality of priority levels may be assigned to a program. The priority assigned to a program may also be based upon the duration of the program, whether the trigger time is before or after the given time point and/or the content of the television program. Different programs from the same media channel may have different priorities and have different positions in the list.

According to various, but not necessarily all, embodiments of the invention there is provided an apparatus comprising; a receiver configured to receive information comprising the trigger time of programs on a plurality of media channels; a processor configured to assign a priority to the programs based on the trigger time of the program relative to a given time point such that programs with a trigger time within a first predetermined time interval of the given time point are assigned a higher priority than programs with a trigger time within a second predetermined time interval of the given time point; and a display configured to present, at the given time point, the programs in a list in order of assigned priority so that programs with a higher assigned priority are presented at a higher position in the list than programs with a lower assigned priority; wherein the processor is configured to detect user selection of a program from the list and in response to the detection configure the apparatus to enable the media channel associated with the selected program to be accessed.

According to various, but not necessarily all, embodiments of the invention there is provided a computer program comprising program instructions for controlling an apparatus, the apparatus comprising a receiver configured to receive information comprising the trigger time of programs on a plurality of media channels and a display configured to present a list of programs wherein user selection of a program from the list enables the media channel associated with the selected program to be accessed, the program instructions providing, when loaded into a processor: means for assigning a priority to the programs based on the trigger time of the program relative to a given time point such that programs with a trigger time within a first predetermined time interval of the given time point are assigned a higher priority than programs with a trigger time within a second predetermined time interval of the given time point; means for controlling the display to present, at the given time point, the programs in a list in order of assigned priority so that programs with a higher assigned priority are presented at a higher position in the list than programs with a lower assigned priority.

According to various, but not necessarily all, embodiments of the invention there is provided a user interface comprising: a display configured to present a list of programs broadcast on a plurality of media channels wherein user selection of a program from the list enables the media channel associated with the selected program to be accessed; wherein the programs in the list are assigned a priority based on the trigger time of the program relative to a given time point such that programs with a trigger time within a first predetermined time interval of the given time point are assigned a higher priority than programs with a trigger time within a second predetermined time interval of the given time point and the programs in the list are presented in order of assigned priority so that programs with a higher assigned priority are presented at a higher position in the list than programs with a lower assigned priority.

According to various, but not necessarily all, embodiments of the invention there is provided a method comprising; receiving information comprising the start time of a plurality of television programs scheduled to be broadcast on a plurality of television channels; assigning a priority from a plurality of priority levels to the television programs wherein the assigned priority is dependent upon the start time of the program relative to a given time point such that programs with a start time within a first predetermined time interval of the assigned time point are assigned a higher priority than programs with a trigger time within a second predetermined time interval of the given time point; and presenting, at the given time point, the television programs in an electronic program guide in order of descending priority so that television programs with a higher assigned priority are presented at a higher position in the electronic program guide than television programs with a lower assigned priority.

The apparatus may be for wireless communication

### BRIEF DESCRIPTION OF THE DRAWINGS

For a better understanding of various examples of embodiments of the present invention reference will now be made by way of example only to the accompanying drawings in which:

FIG. 1 schematically illustrates an electronic apparatus;

FIG. 2 illustrates a flow chart showing method blocks of an embodiment of the present invention;

FIG. 3 illustrates a graphical user interface according to a first embodiment the present invention;

### DETAILED DESCRIPTION OF VARIOUS EMBODIMENTS OF THE INVENTION

The Figures illustrate an apparatus 1 comprising; a transmitter and/or receiver 17 configured to receive 21 information comprising the trigger time of programs on a plurality of media channels; a processor 3 configured to assign 23 a priority to the programs based on the trigger time of the program relative to a given time point such that programs with a trigger time within a first predetermined time interval of the given time point are assigned a higher priority than programs with a trigger time within a second predetermined time interval of the given time point; and a display 11 configured to present 25, at the given time point, the programs in a list in order of assigned priority so that programs with a higher assigned priority are presented at a higher position in the list than programs with a lower assigned priority; wherein the processor 3 is configured to detect 27 user selection of a program from the list and in response to the user selection enable 29 the media channel associated with the selected program to be accessed.

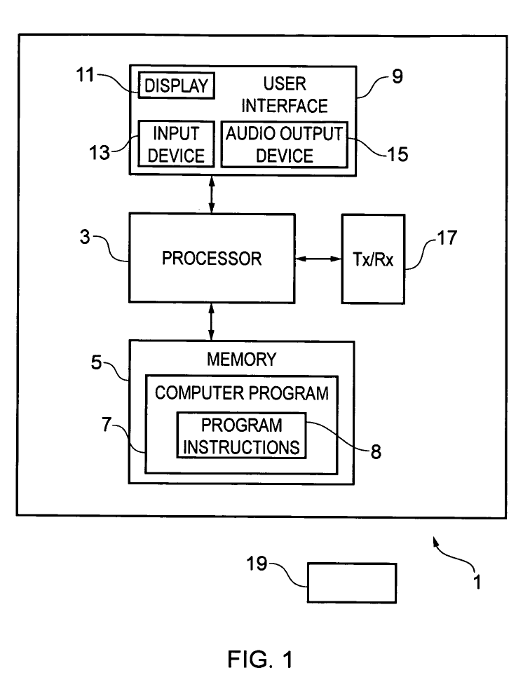

FIG. 1 schematically illustrates an electronic apparatus 1. Only the features referred to in the following description are illustrated. It should, however, be understood that the apparatus 1 may comprise additional features that are not illustrated. The electronic apparatus 1 may be, for example, a personal computer, a personal digital assistant, a mobile cellular telephone, or any other electronic apparatus that enables a user to access television channels or any other media channels such as radio channels. The electronic apparatus 1 may be a handheld apparatus 1 which can be carried in a user's hand, handbag or jacket pocket for example.

The illustrated electronic apparatus 1 comprises: a user interface 9, a transmitter and/or receiver 17 and a controller. In this embodiment the controller comprises a processor 3 and a memory 5.

The controller may be implemented using instructions that enable hardware functionality, for example, by using executable computer program instructions 8 in a general-purpose or special-purpose processor 3 that may be stored on a computer readable storage medium (e.g. disk, memory etc) to be executed by such a processor 3.

The processor 3 is configured to receive input commands from the user interface 9 and to provide output commands to the user interface 9. The processor 3 is also configured to write to and read from the memory 5. The processor 3 is also configured to receive inputs from and provide outputs to the transmitter and/or receiver 17.

In the illustrated embodiment the user interface 9 comprises a display 11, a user input device 13 and an audio output device 15. The user input device 13 may comprise a touch sensitive user input device such as a touch sensitive display configured to enable a user to make inputs via the display 11. The user input device 13 may also comprise a touch pad, a key pad, a joy stick or any other user input device which enables a user to input information into the apparatus 1.

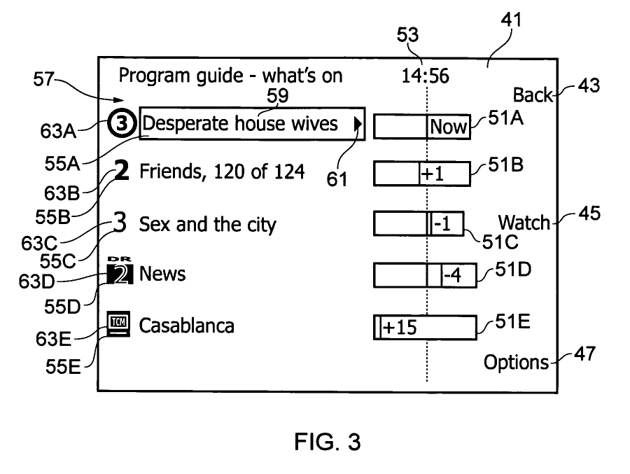

The display 11 is configured to present a graphical user interface 41 to a user. An example of a graphical user interface 41 according to an embodiment of the invention is illustrated in FIG. 3. The display 11 may also be configured to present television programs which are broadcast on television channels and received by the transmitter and/or receiver 17.

The audio output device 15 may be, for example, a loudspeaker. The audio output device 15 may be configured to output audio information which is received by the transmitter and/or receiver 17 such as the accompanying sound to a television program or a radio program.

The transmitter and/or receiver 17 is configured to receive signals broadcast on a plurality of media channels. For example the transmitter and/or receiver 17 may be configured to receive mobile television signals or radio signals. The received signal is then provided to the processor 3 where it is processed before being provided to the user interface 9 where it is presented to a user of the apparatus 1 as images on the display 11 and/or an audio output via the audio output device 15

The transmitter and/or receiver 17 may also be configured to receive information relating to scheduled programs which are to be broadcast on the media channels. The information may include, the channel on which the program is to be broadcast, the trigger time of the program, the content of the program and any other information which may be used to provide an electronic program guide to a user. The information may be stored in the memory 5.

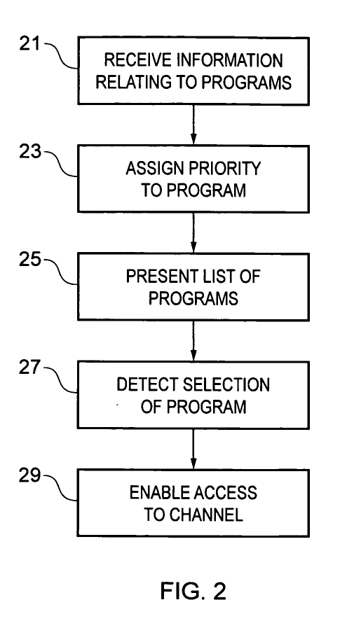

The memory 5 stores a computer program 7 comprising computer program instructions 8 that control the operation of the apparatus 1 when loaded into the processor 3. The computer program instructions 8 provide the logic and routines that enables the apparatus 1 to perform the method illustrated in FIG. 2. The processor 3 by reading the memory 5 is able to load and execute the computer program 3.

The computer program instructions 8 may provide computer readable program means for controlling the display 11 to present a list of programs wherein user selection of a program from the list enables the media channel associated with the selected program to be accessed.

The computer program instructions 8 may also provide computer readable program means for assigning a priority to the programs based on the trigger time of the program relative to a given time point such that programs with a trigger time within a first predetermined time interval of the given time point are assigned a higher priority than programs with a trigger time within a second predetermined time interval of the given time point; and means for controlling the display 11 to present, at the given time point, the programs in a list in order of assigned priority so that programs with a higher assigned priority are presented at a higher position in the list than programs with a lower assigned priority.

The computer program 7 may arrive at the apparatus 1 via any suitable delivery mechanism 19. The delivery mechanism 19 may be, for example, a computer-readable storage medium, a computer program product, a memory device, a record medium such as a CD-ROM or DVD, an article of manufacture that tangibly embodies the computer program 7. The delivery mechanism may be a signal configured to reliably transfer the computer program 7. The apparatus 1 may propagate or transmit the computer program 7 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

A method of controlling the apparatus 1, according to the present invention, is illustrated schematically in FIG. 2.

At block 21 the transmitter and/or receiver 17 receives information relating to programs which are scheduled to be broadcast on a plurality of media channels. The programs may be television programs which are scheduled to be broadcast on mobile television channels. The programs may also include radio programs which may be broadcast on media channels such as radio channels.

The information received may include information relating to the trigger times of the programs. A trigger time is the time at which a particular point in a program occurs. A single program may have a plurality of trigger times. For example, the trigger time may be the time at which the program starts and/or the time at which the program ends. In other embodiments the trigger time may be the time at which particular content of a program is broadcast, for example, it may be the time at which the news headlines are due to be broadcast in a news bulletin.

The information received may also comprise information relating to the duration of the programs. This may be received as information relating to a trigger time corresponding to the start of the program and a trigger time corresponding to the end of the program.

The information received may also comprise information relating to the content of the programs. For example it may include a brief synopsis of the program or an indication of the type or program, for example, whether it is a documentary or a drama.

At block 23 the processor 3 assigns a priority to the programs which are scheduled to be broadcast. The priority which is assigned 23 to each program is dependent upon the trigger time of the program relative to a given point in time. The given point in time may be the time instance at which the assigning 23 is occurring or a time within the next few minutes of the assigning 23.

The priority assigned may be any one of a number of different levels of priority. The highest priority may be given to programs with a trigger time within a first predetermined time interval and a lower priority may be given to programs with trigger time within a second predetermined time interval. For example, programs with a start time which is close to the given point in time, that is where the time interval between the given point in time and the start time is short, would be just about to start or would have just started and so would be assigned a higher priority because a user who is only accessing the channel for a short period of time may be able to watch or listen to all or almost all of the program. Programs with a start time which is further away from the given point in time would have a lower priority because if the given point in time is after the start time then the user would have already missed a significant proportion of the program and if the given point in time is before the start time then the user would have to wait for these programs to begin.

Other information may also be taken into account when assigning the priority level such as the duration of the programs. For example, in instances where the program has already started, that is the start trigger time is in a time interval before the given time point, the priority assigned to the program may also may depend upon the duration of the program as well as the amount of time which has passed since the program started so that it is the proportion of the program which has already been broadcast which is taken into account. For example a film may be scheduled to be broadcast for over an hours and a half so if a user misses the first five minutes they will have only missed a small proportion of the film and would still be able to enjoy the rest of the film. Therefore the film may still be assigned a high priority. Conversely other programs may only be broadcast for ten minutes, in which case if a user has missed the first five minutes they would have missed half of the program and may not be able to enjoy the second half because they have already missed such a significant proportion of the program. These programs would therefore be assigned a lower priority.

In some embodiments the percentage of the program which has already been broadcast may be taken into account. For example a program which has had less than 25% already broadcast may be assigned a higher priority than a program which has had less than 25% already broadcast. The priority level assigned may also be dependent upon the duration of the program because missing the first part of a long program may not have as much affect on the users enjoyment of the program as missing the first part of a shorter program. For example a program which has had more than 25% already broadcast, but lasts for longer than a predetermined duration, for instance longer than one hour, may be given a higher priority than a program which has had more than 25% already broadcast but lasts for less than the predetermined duration.

Also where a user is only able to access the channels for a given period of time, for example if they are watching mobile television whilst traveling for a short period of time, they may only want to access programs which will be completed within that time period. In such embodiments programs with an end trigger time occurring within the time period for which the user can access the channel may be assigned a higher priority than programs which have an end point outside the time period because the user would not be able to access the end of the program which may be frustrating for the user.

The assigned priority may also dependent upon the content of the program. For example the user maybe able to provide information relating to their preferred type of programs so that these programs are assigned a higher priority than other types of programs.

In some embodiments the information relating to the type of programs preferred by the user may be obtained by monitoring the types of programs which the user typically selects. For example if a user selects programs of a first genre, for instance drama programs, more often than they select programs of a second genre, for instance sport, then this information may be used to assign a higher priority level to drama programs than to sport programs.

Also some programs may have content so that the trigger times are not particularly relevant, for example a program may be a music program during which a plurality of songs are broadcast and so it may not be important to a user that they access the start of such a program. Therefore in some embodiments of the invention there may be a priority level for such programs.

It is to be appreciated that a number of factors other than the trigger time of the program can be taken into account when assigning a priority to a program and that the exact algorithm used and the weighting given to each factor may vary between embodiments.

At block 25 a list 57 of the scheduled programs is presented on the display 11. The list 57 is presented in order of the assigned priority so that programs with the higher assigned priority level are presented at a higher or more prominent position in the list 57 than those with a lower assigned priority.

As the programs in the list 57 are presented in order of priority different programs on the same channel may appear at different positions within the list 57.

At block 27 the processor 3 detects user selection of a program from the list. The selection may be made using the user input device 13.

In response to the detection 27 of the user selection of a program the processor 3 is configured to control the apparatus 1 to enable access to the media channel on which the program is being broadcast. For example if the selected program is a television program the processor will configure the transmitter and/or receiver 17 to receive the channel on which the program is being broadcast and control the display 11 and the audio output device 15 to present the television program to a user.

The blocks illustrated in FIG. 2 may represent steps in a method and/or sections of code in the computer program 7. The illustration of a particular order to the blocks does not necessarily imply that there is a required or preferred order for the blocks and the order and arrangement of the block may be varied. Furthermore, it may be possible for some steps to be omitted.

FIG. 3 illustrates a graphical user interface 41 according to an embodiment of the invention. The graphical user interface 41 may be presented on the display 11 which may be a touch sensitive display. The graphical user interface 41 in the illustrated embodiment is configured to enable access to a plurality of television channels. It is to be appreciated that in other embodiments the graphical user interface 41 may be used to enable access to different types of media channels such as radio channels.

The graphical user interface 41 comprises a clock icon 53 which indicates the current time. In the particular embodiment in FIG. 3 the current time is the given time point to which the trigger times of the scheduled television programs are compared in order to assign a priority.

The graphical user interface 41 also comprises a list 57 of television programs 55A to 55E. The name of television program is presented in the list 57 adjacent to a corresponding icon 51A to 51E which indicates the start time of the of the television program relative to the current time. The name of each program is also presented adjacent to an icon 63A to 63E which indicates the channel on which the program is broadcast.

The programs 55A to 55E are presented in the list 57 in order of descending priority so that the program with the highest priority is presented at the top of the list 57 and programs with a lower priority are presented further down the list 57.

In this particular embodiment the program Desperate Housewives 55A has the highest priority because, as indicated by the icon 51A, it is starting immediately and so has the closest start time relative to the given time point. As Desperate Housewives has the highest priority it is presented at the top of the list 57.

The program Friends 55B has the next closest start time, as it started one minute before the given time point as indicated by the number +1 on the icon 51B, and so it has a lower priority than Desperate Housewives but a higher priority than he other programs and is presented second in the list 57.

The program Sex and the City 55C is presented third in the list 57. This also has a start time which is within one minute of the given time point, however this is due to start in one minute as is indicated by the number −1 on the icon 51C. As the user will have to wait before this program begins this program has a lower priority and so appears below Friends 55B in the list 57 even though it has a start time which is the same distance in time from the given point in time.

The program news 55D is due to start in four minutes, as indicated by the −4 in the icon 51D. As this start time is more than one minute from the given time point the program news 55D has a lower priority than the program Sex and the City 55C and Friends 55B and so is presented further down the list 57.

The program Casablanca 55E started fifteen minutes before the given time point as indicated by the number +15 in the icon 51E. However as this is a film which lasts for over an hour and a half, the fifteen minutes which have been missed is not a significant proportion of the total program and the user may still be able to enjoy the rest of the film so the program Casablanca 55E is still presented in the list 57 but is assigned a lower priority.

It is to be appreciated that the number of programs which can be presented on the list 57 at a single time is limited by the size of the display 11. Therefore a user may be able to access other programs in the list by scrolling down, for example by making a downward trace input on a touch sensitive display 11 or by using directional key inputs.

The graphical user interface 41 also comprises three icons, a back icon 43, a watch icon 45 and an options icon 47. In embodiments where the graphical user interface is presented on a touch sensitive display 11 the icons may indicate an area of the display 11 which, when actuated by a user input will enable the apparatus 1 to perform the function associated with the icon 43, 45, 47. In other embodiments the icons 43, 45, 47 may be associated with soft keys of the apparatus 1 so that actuation of a soft key will perform the function associated with it. The icons 43, 45, 47 may be positioned on the display 11 so that they are presented adjacent to such soft keys.

In response to actuation of the back icon 43 the processor 3 will control the apparatus to exit the program guide mode and return to the mode which the apparatus 1 was in before program guide mode was entered.

Actuation of the watch icon 45 will select the currently highlighted program from the list 57. In the embodiment illustrated in FIG. 3 the currently highlighted program is Desperate Housewives 55A. The program is highlighted by having a box 59 presented around the name of the program and by having an arrow 61 icon presented adjacent to the name of the program. The apparatus 1 is configured to enable a user to change which program is highlighted using the user input device 13. For example where the graphical user interface 41 is presented on a touch sensitive display 11 the user may be able to highlight a program by touching the area of the display 11 in which the name of the program is presented.

In response to selection of a program the processor 3 will configure the apparatus 1 to access the television channel on which the selected program is broadcast and enable this to be presented to the user. In this particular embodiment the television program will replace the list 57 of programs on the display 11.

Actuation of the options icon 47 will enable a user to access a menu of options. The options may be associated with the currently highlighted program in the list 57, for example, the options may enable a user to access further information relating to the program or enable a user to set a reminder for when the program is about to begin. The options may also be associated with the program guide application, for example it may enable a user to personalize the way in which priorities are assigned to programs, for example by selecting their preferred type of content or duration of program.

In FIG. 3 the numbers in the icons 51A to 51E indicate whether or not a program has started or is just about to start. In other embodiments of the invention this could be indicated by text, for example by displaying the words “just started” or “about to start”. Alternatively this could be indicated by another visual indication such as the colour of the icon 51A to 51E. For example, a red icon may indicate that a program is about to start but a blue icon may indicate that the program has already started.

Therefore FIG. 3 illustrates a graphical user interface 41 in which programs which are scheduled to be broadcast are presented in an ordered list 57 so that programs with a start time close to the present time are automatically presented higher up the list. The enables a user to quickly and easily access television programs which have just started or are just about to start and so does not have to spend time navigating through a lengthy list in order to find such programs.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising;
receiving information comprising the trigger time of programs on a plurality of media channels;
assigning a priority to the programs based on the trigger time of the program relative to a given time point such that programs with a trigger time within a first predetermined time interval of the given time point are assigned a higher priority than programs with a trigger time within a second predetermined time interval of the given time point; and
presenting, at the given time point, the programs in a list in order of assigned priority so that programs with a higher assigned priority are presented at a higher position in the list than programs with a lower assigned priority and user selection of a program from the list enables the media channel associated with the selected program to be accessed.

2. A method as claimed in claim 1 wherein the trigger time is the start time of the program.

3. A method as claimed in claim 1 wherein the plurality of media channels comprise television channels.

4. A method as claimed in claim 1 wherein any one of a plurality of priority levels may be assigned to a program.

5. A method as claimed in claim 1 wherein the priority assigned to a program is also based upon the duration of the program.

6. A method as claimed in claim 1 wherein the priority assigned to a program may also be based upon whether the trigger time is before or after the given time point.

7. A method as claimed in claim 1 wherein the priority assigned to a program may also be based upon the content of the program.

8. A method as claimed in claim 1 wherein different programs from the same channel have different priorities and have different positions in the list.

9. An apparatus comprising;
a receiver configured to receive information comprising the trigger time of programs on a plurality of media channels;
a processor configured to assign a priority to the programs based on the trigger time of the program relative to a given time point such that programs with a trigger time within a first predetermined time interval of the given time point are assigned a higher priority than programs with a trigger time within a second predetermined time interval of the given time point; and
a display configured to present, at the given time point, the programs in a list in order of assigned priority so that programs with a higher assigned priority are presented at a higher position in the list than programs with a lower assigned priority; wherein
the processor is configured to detect user selection of a program from the list and in response to the detection configure the apparatus to enable the media channel associated with the selected program to be accessed.

10. An apparatus as claimed in claim 9 wherein the trigger time is the start time of the program.

11. An apparatus as claimed in claim 9 wherein the plurality of media channels comprise television channels.

12. An apparatus as claimed in claim 9 wherein any one of a plurality of priority levels may be assigned to a program.

13. An apparatus as claimed in claim 9 wherein the priority assigned to a program is also based upon the duration of the program.

14. An apparatus as claimed in claim 9 wherein the priority assigned to a program is also based upon whether the trigger time is before or after the given time point.

15. An apparatus as claimed in claim 9 wherein the priority assigned to a program is also based upon the content of the program.

16. An apparatus as claimed in claim 9 wherein different programs from the same channel have different priorities and have different positions in the list.

17. An apparatus as claimed in claim 9 wherein the apparatus is a mobile communications device.

18. A computer program comprising program instructions for controlling an apparatus, the apparatus comprising a receiver configured to receive information comprising the trigger time of programs on a plurality of media channels and a display configured to present a list of programs wherein user selection of a program from the list enables the media channel associated with the selected program to be accessed, the program instructions providing, when loaded into a processor:
means for assigning a priority to the programs based on the trigger time of the program relative to a given time point such that programs with a trigger time within a first predetermined time interval of the given time point are assigned a higher priority than programs with a trigger time within a second predetermined time interval of the given time point; and
means for controlling the display to present, at the given time point, the programs in a list in order of assigned priority so that programs with a higher assigned priority are presented at a higher position in the list than programs with a lower assigned priority.

19. A physical entity embodying the computer program as claimed in claim 18.

20. An electromagnetic carrier signal carrying the computer program as claimed in claim 18.

21. A computer program comprising program instructions for causing a computer to perform the method of claim 1.

22. A user interface comprising:
a display configured to present a list of programs broadcast on a plurality of media channels wherein user selection of a program from the list enables the media channel associated with the selected program to be accessed;
wherein the programs in the list are assigned a priority based on the trigger time of the program relative to a given time point such that programs with a trigger time within a first predetermined time interval of the given time point are assigned a higher priority than programs with a trigger time within a second predetermined time interval of the given time point and the programs in the list are presented in order of assigned priority so that programs with a higher assigned priority are presented at a higher position in the list than programs with a lower assigned priority.

23. A user interface as claimed in claim 22 wherein the trigger time is the start time of the program.

24. A user interface as claimed in claim 22 wherein the plurality of media channels comprises television channels.

25. A method comprising;
receiving information comprising the start time of a plurality of television programs scheduled to be broadcast on a plurality of television channels;
assigning a priority from a plurality of priority levels to the television programs wherein the assigned priority is dependent upon the start time of the program relative to a given time point such that programs with a start time within a first predetermined time interval of the given time point are assigned a higher priority than programs with a trigger time within a second predetermined time interval of the given time point; and
presenting, at the given time point, the television programs in an electronic program guide in order of descending priority so that programs with a higher assigned priority are presented at a higher position in the electronic program guides than programs with a lower assigned priority.
